(19) United States
(12) Patent Application Publication
(10) Pub. No.: US 2024/0278755 A1
(43) Pub. Date: Aug. 22, 2024

(54) APPARATUS AND METHOD FOR CONTROLLING BRAKE SYSTEM IN CASE OF STEERING SYSTEM FAILURE

(71) Applicant: HL MANDO CORPORATION, Gyeonggi-do (KR)

(72) Inventor: Jinsoo KIM, Seoul (KR)

(21) Appl. No.: 18/534,567

(22) Filed: Dec. 9, 2023

(30) Foreign Application Priority Data
Feb. 16, 2023 (KR) 102023-0020918
Jun. 26, 2023 (KR) 10-2023-0081629

(51) Int. Cl. B60T 8/1755; B60T 8/24

(52) U.S. Cl. CPC B60T 8/1755; B60T 8/246; B60T 2260/02

(57) ABSTRACT

An apparatus for controlling a brake system includes: an upper controller generating calculating a first control signal so that a difference between a control target and a vehicle state is equal to or less than a threshold through state-feedback control; and a lower controller converting the first control signal into a braking torque for each of vehicle wheels, and distributing a braking pressure to actuators of the vehicle wheels through the brake system so that the braking torque for each which can be generated.

### CROSS-REFERENCE TO RELATED APPLICATIONS

This application claims priority under 35 U.S.C. § 119 to Korean Patent Application No. 10-2023-0020918, filed on Feb. 16, 2023, and Korean Patent Application No. 10-2023-0081629, filed on Jun. 26, 2023, in the Korean Intellectual Property Office (KIPO), each of which is incorporated by reference herein in their entireties.

### TECHNICAL FIELD

The present disclosure generally relates to a technology that assists or replaces steering of a vehicle using differential braking. More particularly, the present disclosure relates to an apparatus and a method for controlling a brake system in case of a steering system failure.

### BACKGROUND

In recent years, as the efficiency of a by-wire scheme vehicle chassis system has emerged, an automotive industry has been actively developing products such as steer-by-wire (SbW), brake-by-wire (BbW), etc. In particular, in the case of the SbW system, a steering wheel manipulation of a driver and a rack actuator operation are made by an electrical motor signal without a physical connection (column) in the middle between a steering wheel and vehicle wheels. Therefore, when a failure such as a communication disruption occurs, a problem caused by such as failure cannot be fixed by solved by a physical manipulation of the driver. In this way, when there is a problem in transferring a target steering signal of the driver (or autonomous driving), a vehicle immediately loses a normal driving trajectory, and may cause a serious traffic accident. In this aspect, before mass-production and supply of the SbW system, even though the failure occurs, an importance of a redundancy function which can secure safety is emerging.

Since the 1990s, function research has been continuously conducted to assist and replace the steering of vehicles using differential braking. Physically, the differential braking generates a difference between left and right longitudinal forces in the driving vehicle, and a yaw moment and lateral force are created for turning. At this time, a wheel angle occurs due to a scrub radius related to a steering geometry between a tire and a road surface. Here, a size and a sign of the scrub radius are one of the main factors that influence a wheel angle generation direction (e.g., a transverse motion of the vehicle). When such a mechanism is used, it is expected that it will be possible to implement a steering motion for securing minimum steering redundancy such as stopping the vehicle at a safe place or maintaining a traffic lane for a predetermined time in a situation in which steering manipulation is impossible (for example, the SbW system fails).

In the early 1998 research, the influence of the scrub radius is not considered, and the differential braking control is attempted by focusing on the moment generated only by the left and right differential braking. In another research, more effective turning can be made by using additional moments as the differential braking at the time of steering turning. However, this may correspond to only a case where the wheel angle is stuck, and when the differential braking is actually applied in a situation in which there is no steering intervention of the driver, the wheel angle is not stuck by the influence of the scrub radius, but the wheel gradually rotates in one direction, which influences turning. Such an influence needs to be particularly considered upon the differential braking control. In yet another research, there was an attempt to implement a differential braking function by reflecting a steering geometry model, but a ground and reliability of the model are not sufficient, and various scrub radius values are considered, but are limited to a negative category, so a satisfactory result is shown upon the differential braking control while the steering wheel is fixed. In this case, in the SbW system failure, a free-rolling phenomenon of the wheel angle that is most concerned is not considered.

In recent years, the SbB system which reflects scrub radius setting to the differential braking control has emerged. The conventional system is developed with a goal of securing a favorable rotation radius by generating a wheel angle of the axis on the back of a trailer through automatic braking control when the trailer rotates at low speed. Universally, trailer vehicles require additional mounting of a backlash wheel steering system, and the function can be replaced with the differential braking control. In addition, this conventional technology is limited to industrial trailer vehicles and is far from a function of securing redundancy of a universal SbW system. In addition, the availability of the system is confirmed only in a limited scenario of a specific road curvature.

As mentioned in the existing researches, a differential braking based steering ability of the vehicle is largely based on a scrub radius design. The scrub radius is determined and designed by a manufacturer according to a driving purpose of the vehicle generally developed. For example, in the case of racing-purpose vehicles, which mainly adopt a rear wheel drive (RWD) scheme, a front wheel is designed with a toe out to secure advantageous straightness when accelerating the vehicle and a positive scrub radius may be adopted for the design. On the other hand, in the case of mass production entry-level vehicles, it is common to design as a negative scrub radius for the following vehicle stability. For example, when a circuit failure occurs in an X-split type braking system, a fault circuit is not braked, and braking force is delivered only to one remaining circuit, and in this case, when the vehicle is designed by the negative scrub radius, the straightness of the vehicle is secured while a wheel angle rotates in an opposite direction to an application direction in which differential braking force is applied. Such a phenomenon is similarly applied in order to secure the straightness of the vehicle on a split road surface. However, in a mechanism in which the wheel angle is generated reversely to a yaw behavior upon differential braking, a yaw moment generated by the differential braking and a transverse movement distance are offset, and there may be a problem in that the performance and efficiency of the differential braking control which aims at securing the steering ability deteriorate.

### SUMMARY

In order to solve the problem, some embodiments of the present disclosure have been made in an effort to secure a steering ability of a vehicle through differential braking control in case of a steer-by-wire system failure.

Certain embodiments of the present disclosure have also been made in an effort to enable a driver to steer a vehicle through differential braking control in the case of failure in the steer-by-wire system.

However, a technical object to be achieved by the exemplary embodiment of the present disclosure is not limited to the technical objects and there may be other technical objects.

An exemplary embodiment of the present disclosure provides an apparatus for controlling a brake system which includes: an upper controller calculating a first control signal so that a difference between a control target and a vehicle state is equal to or less than a threshold through state-feedback control; and a lower controller converting the first control signal into a braking torque for each of left and right front and rear wheels, and distributing a braking pressure to an actuator through a brake system so that the braking torque for each left and right front and rear wheel may be generated. Here, it is preferable that the threshold is set so that the difference between the control target and the vehicle state becomes the minimum or almost equal.

In an exemplary embodiment, the apparatus further includes a disturbance compensator generating a second control signal based on a disturbance generated by an external factor, and the first control signal and the second control signal are added to generate a third control signal.

In an exemplary embodiment, the first control signal is calculated in real time.

In an exemplary embodiment, the external factor is at least one of road surface friction, slope, temperature, altitude, vehicle load, tire condition, and traffic situation.

In an exemplary embodiment, the control target represents the target yaw rate, and the target yaw rate means a yaw rate of the vehicle when normal steering is performed during the driving of the vehicle.

In an exemplary embodiment, the target yaw rate is determined by using a yaw rate map generated by collecting data from the yaw rate generated according to manipulation of the vehicle.

In an exemplary embodiment, the target yaw rate is determined according to the driving speed and the steering manipulation amount through the 2-DOF transverse vehicle dynamics model.

In an exemplary embodiment, the state-feedback control adopts a state space model in which a steering geometry model is applied to a 3-DOF transverse vehicle dynamic model.

In an exemplary embodiment, a longitudinal element of the steering geometry model is applied to the transverse vehicle dynamics model, in the transverse vehicle dynamics model, a size and a sign of a scrub radius are determined by a slope of a king-pin axis, a horizontal offset of a wheel center, and an effective wheel size, and a value of the scrub radius is applied by changing a negative scrub radius value to a positive scrub radius value by mounting a spacer between a wheel and a brake disk or changing the slope of the king-pin axis.

In an exemplary embodiment, a state space model in which the steering geometry model is applied to the 3-DOF transverse vehicle dynamics model is represented by Equation 1 below.

$$\frac{d}{dt} [ \begin{matrix}\dot{y} \\ \dot{ψ}\end{matrix} ] = [ \begin{matrix}\frac{- 2 {C}_{α r} + {mr}_{eff} {\dot{ω}}_{w}}{m \dot{x}} & \frac{2 {C}_{α r} {l}_{r} - m {\dot{x}}^{2} + {mr}_{eff} {\dot{ω}}_{w} {l}_{f}}{m \dot{x}} \\ \frac{2 {C}_{α r} {l}_{r} + {mr}_{eff} {\dot{ω}}_{w} {l}_{f}}{{I}_{z} \dot{x}} & \frac{- 2 {C}_{α r} {l}_{r}^{2} + {mr}_{eff} {\dot{ω}}_{w} {l}_{f}^{2}}{{I}_{z} \dot{x}}\end{matrix} ] [ \begin{matrix}\dot{y} \\ \dot{ψ}\end{matrix} ] + [ \begin{matrix}α \{ - \frac{( 2 {C}_{α f} + {mr}_{eff} {\dot{ω}}_{w} ) s}{2 {C}_{α f} mt} \} \\ - α \{ \frac{( 2 {C}_{α f} {l}_{f} + {mr}_{eff} {\dot{ω}}_{w} {l}_{f} ) s}{2 {C}_{α f} {I}_{z} t} + \frac{D}{2 {I}_{z}} \} - ( 1 - α ) \frac{D}{2 {I}_{z}}\end{matrix} ] [ Δ {F}_{x} ] \qquad ( Equation 1 )$$

Where, C_{af} and Cₐᵣ represent cornering rigidities of the front wheel and the rear wheel, respectively, l_{f} represents a distance up to a front wheel axis from the center of the vehicle, lᵣ represents a distance up to a rear wheel axis from the center of the vehicle, m represents a mass of the vehicle, r_{eff} represents an effective tire radius, \dot{ω}_{w} represents a rotational wheel acceleration, ÿ represents a transverse acceleration, \dot{y} represents a transverse speed, r represents a proportional coefficient, I_{z} represents an inertial moment of the vehicle for a z axis, ΔF_{xf} represents a difference between left and right longitudinal forces of a front wheel, and ΔFₓ represents a difference in longitudinal force.

In an exemplary embodiment, a first control signal becomes a state-feedback control input in the state space model, and in the state-feedback control input, a control gain K is determined by placing a representative pole at a location where the control stability is secured.

In an exemplary embodiment, braking torques are applied to left front and rear wheels when a value of the third control signal is a positive number and braking torques are applied to right front and rear wheels when the value of the third control signal is a negative number.

In an exemplary embodiment, the brake system may be an integrated dynamic brake (IDB) system, an anti-lock brake system (ABS) in the IDB, and an electronic stability control (ESC) logic may be executed.

Another exemplary embodiment of the present disclosure provides an apparatus for controlling a brake system which includes: a failure detection unit detecting whether a steering signal is abnormal; a steering wheel angle sensor (SAS) sensing an angle of a steering wheel; yaw rate generation unit generating a target yaw rate from a manipulation amount of the steering wheel angle sensor; and an upper controller calculating a first control signal so that a difference between a control target and a vehicle state is equal to or less than a threshold through state-feedback control and a lower controller converting the first control signal into a braking torque for each of left and right front and rear wheels, and distributing a braking pressure to an actuator through a brake system so that the braking torque for each left and right front and rear wheel may be generated.

In an exemplary embodiment, in the detecting whether the steering signal is abnormal, it is detected whether a manipulation signal of a steering wheel is delivered to a wheel steering actuator due to a communication error in a steer-by-wire (SbW) system.

In an exemplary embodiment, the yaw rate generation unit generates a control target based on a steering wheel angle sensor manipulation amount of the driver in the case of the SbW system failure.

In an exemplary embodiment, when a vehicle is in an autonomous driving situation, a steering wheel manipulation signal of the driver is replaced with a steering angle control amount which keeps a lane or needs to change the lane.

In an exemplary embodiment, the apparatus further includes a disturbance compensator generating a second control signal based on a disturbance generated by an external factor, and the adder adds the first control signal and the second control signal to generate a third control signal.

In an exemplary embodiment, the first control signal is calculated in real time.

In an exemplary embodiment, the external factor is at least one of road surface friction, slope, temperature, altitude, vehicle load, tire condition, and traffic situation.

In an exemplary embodiment, the control target represents the target yaw rate, and the target yaw rate means a yaw rate of the vehicle when normal steering is performed during the driving of the vehicle.

In an exemplary embodiment, the target yaw rate is determined by using a yaw rate map generated by collecting data from the yaw rate generated according to manipulation of an actual test vehicle.

In an exemplary embodiment, the target yaw rate is determined according to the driving speed and the steering manipulation amount through the 2-DOF transverse vehicle dynamics model by Equation 2 below.

$$\ddot{y} = - \frac{{C}_{a f} + {C}_{ar}}{m {V}_{x}} \dot{y} + \{ - {V}_{x} - \frac{{l}_{f} {C}_{af} - {l}_{r} {C}_{ar}}{m {V}_{x}} \} {\dot{ψ}}^{des} + \frac{{C}_{af}}{m \cdot r} {δ}^{SW} \qquad ( Equation 2 )$$

$$\ddot{ψ} = - \frac{2 {l}_{f} {C}_{af} - 2 {l}_{r} {C}_{ar}}{{I}_{z} {V}_{x}} \dot{y} + \{ - \frac{2 {l}_{f}^{2} {C}_{af} + 2 {l}_{r}^{2} {C}_{ar}}{{I}_{z} {V}_{x}} \} \dot{ψ} + \frac{2 {l}_{f} {C}_{af}}{{I}_{z}} {δ}^{SW}$$

$${\dot{ψ}}^{des} = \int \ddot{ψ}$$

Where, δ^{zw} represents a steering wheel angle, C_{af} and Cₐᵣ represent cornering rigidities of the front wheel and the rear wheel, respectively, l_{f} represents a distance up to a front wheel axis from the center of the vehicle, lᵣ represents a distance up to a rear wheel axis from the center of the vehicle, I_{z} represents an inertia moment of the vehicle for a z axis, m represents a mass of the vehicle, Vₓ represents the driving speed of the vehicle, each of ÿ and \dot{y} represents a transverse acceleration, r represents a proportional coefficient, and \dot{ψ}^{des} represents the target yaw rate.

In an exemplary embodiment, the state-feedback control adopts a state space model in which a steering geometry model is applied to a 3-DOF transverse vehicle dynamic model.

In an exemplary embodiment, in the steering geometry model, a longitudinal element is applied to a transverse vehicle dynamics model, and is represented by a front wheel steering angle (δ_{f}) due to a left-right longitudinal force difference upon differential braking according to Equation 3 below.

$${δ}_{f} = β + \frac{{l}_{f}}{\dot{x}} \dot{ψ} - \frac{s}{2 {C}_{α f} \cdot t} Δ {F}_{xf} , where β ≅ \frac{\dot{y}}{\dot{x}}$$

Where, ΔF_{xf} represents a front wheel left-right longitudinal force difference, s represents a scrub radius, and t represents a mechanical trail due to a caster angle.

In an exemplary embodiment, the size and the sign of the scrub radius in Equation 3 above are determined by a slope of a king-pin axis, a horizontal offset of a wheel center, and an effective wheel size, and a value of the scrub radius is applied by changing a negative scrub radius value to a positive scrub radius value by mounting a spacer between a wheel and a brake disk or changing the slope of the king-pin axis.

In an exemplary embodiment, a state space model in which the steering geometry model is applied to the 3-DOF transverse vehicle dynamics model is represented by Equation 4 below.

$$\frac{d}{dt} [ \begin{matrix}\dot{y} \\ \dot{ψ}\end{matrix} ] = [ \begin{matrix}\frac{- 2 {C}_{α r} + {mr}_{eff} {\dot{ω}}_{w}}{m \dot{x}} & \frac{2 {C}_{α r} {l}_{r} - m {\dot{x}}^{2} + {mr}_{eff} {\dot{ω}}_{w} {l}_{f}}{m \dot{x}} \\ \frac{2 {C}_{α r} {l}_{r} + {mr}_{eff} {\dot{ω}}_{w} {l}_{f}}{{I}_{z} \dot{x}} & \frac{- 2 {C}_{α r} {l}_{r}^{2} + {mr}_{eff} {\dot{ω}}_{w} {l}_{f}^{2}}{{I}_{z} \dot{x}}\end{matrix} ] [ \begin{matrix}\dot{y} \\ \dot{ψ}\end{matrix} ] + [ \begin{matrix}α \{ - \frac{( 2 {C}_{α f} + {mr}_{eff} {\dot{ω}}_{w} ) s}{2 {C}_{α f} mt} \} \\ - α \{ \frac{( 2 {C}_{α f} {l}_{f} + {mr}_{eff} {\dot{ω}}_{w} {l}_{f} ) s}{2 {C}_{α f} {I}_{z} t} + \frac{D}{2 {I}_{z}} \} - ( 1 - α ) \frac{D}{2 {I}_{z}}\end{matrix} ] [ Δ {F}_{x} ] \qquad ( Equation 4 )$$

Where, C_{af} and Cₐᵣ represent cornering rigidities of the front wheel and the rear wheel, respectively, l_{f} represents a distance up to a front wheel axis from the center of the vehicle, lᵣ represents a distance up to a rear wheel axis from the center of the vehicle, m represents a mass of the vehicle, r_{eff} represents an effective tire radius, \dot{ω}_{w} represents a rotational wheel acceleration, ÿ represents a transverse acceleration, \dot{y} represents a transverse speed, r represents a proportional coefficient, I_{z} represents an inertial moment of the vehicle for a z axis, and ΔFₓ represents a difference in longitudinal force.

In an exemplary embodiment, a first control signal becomes a state-feedback control input in the state space model, and the state-feedback control input is represented by Equation 5 below, and

$${F}_{DB}^{des} = Δ {F}_{x} = U ( k ) = - K \cdot X \qquad ( Equation 5 )$$

the control gain K is determined by placing a representative pole at a location where the control stability is secured.

In an exemplary embodiment, the control gain K is calculated from two selected poles.

In an exemplary embodiment, braking torques are applied to left front and rear wheels when a value of the third control signal is a positive number and braking torques are applied to right front and rear wheels when the value of the third control signal is a negative number.

In an exemplary embodiment, the brake system may include at least one of an integrated dynamic brake (IDB) system, an anti-lock brake system (ABS) in the IDB, and an electronic stability control (ESC) logic.

Yet another exemplary embodiment of the present disclosure provides a method for controlling a brake system which includes: calculating, by an upper controller, a first control signal so that a difference between a control target and a vehicle state is equal to or less than a threshold through state-feedback control; inputting the first control signal to a lower controller; converting, by the lower controller, the input first control signal into a braking torque for each of front and rear wheels of a vehicle; and distributing, by the lower controller, a braking pressure to an actuator through a brake system so that the braking torque for each of the front and rear wheels may be generated.

In an exemplary embodiment, the method further includes: generating, by a disturbance compensator, a second control signal based on a disturbance generated by an external factor; adding, by an adder, the first control signal and the second control signal to generate a third control signal before the first control signal is input into the lower controller when the second control signal is generated by the disturbance compensator; and inputting the third control signal to the lower controller.

In an exemplary embodiment, the external factor is at least one of road surface friction, slope, temperature, altitude, vehicle load, tire condition, and traffic situation.

In an exemplary embodiment, the control target represents the target yaw rate, and the target yaw rate means a yaw rate of the vehicle when normal steering is performed during the driving of the vehicle.

In an exemplary embodiment, the method includes determining the target yaw rate by using a yaw rate map generated by collecting data from the yaw rate generated according to manipulation of an actual test vehicle.

In an exemplary embodiment, the method includes determining the target yaw rate according to the driving speed and the steering manipulation amount through the 2-DOF transverse vehicle dynamics model.

In an exemplary embodiment, the state-feedback control adopts a state space model in which a steering geometry model is applied to a 3-DOF transverse vehicle dynamic model.

In an exemplary embodiment, a longitudinal element of the steering geometry model is applied to the transverse vehicle dynamics model, in the transverse vehicle dynamics model, a size and a sign of a scrub radius are determined by a slope of a king-pin axis, a horizontal offset of a wheel center, and an effective wheel size, and the method includes applying a value of the scrub radius by changing a negative scrub radius value to a positive scrub radius value by mounting a spacer between a wheel and a brake disk or changing the slope of the king-pin axis.

In an exemplary embodiment, a first control signal becomes a state-feedback control input in the state space model, and in the state-feedback control input, a control gain K is determined by placing a representative pole at a location where the control stability is secured.

In an exemplary embodiment, the method includes applying braking torques to left front and rear wheels when a value of the third control signal is a positive number and applying braking torques to right front and rear wheels when the value of the third control signal is a negative number.

In an exemplary embodiment, the brake system may include at least one of an integrated dynamic brake (IDB) system, an anti-lock brake system (ABS) in the IDB, and an electronic stability control (ESC) logic.

According to some embodiments of the present disclosure, there is an effect in that it is possible to cope with a steering failure through differential braking control with respect to a degree of a driver's steering manipulation will in case of failure in an SbW system.

According to certain embodiments of the present disclosure, there is an effect in that a steering wheel manipulation of a driver can be replaced with a steering angle control amount at which a lane is kept or needs to be changed and controlled even in an autonomous driving situation.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram illustrating a configuration of a brake system according to an exemplary embodiment of the present disclosure.

FIG. 2 is a diagram illustrating a 3-DOF transverse direction vehicle dynamic model according to an exemplary embodiment of the present disclosure.

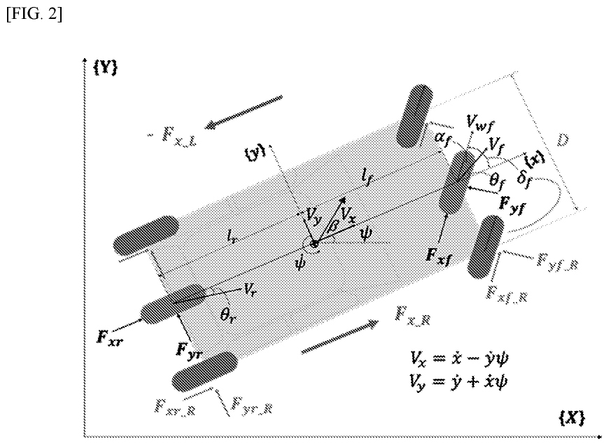

FIG. 3 is a diagram illustrating a scrub radius by a steering mechanism geometry design according to an exemplary embodiment of the present disclosure.

FIG. 4 is a diagram illustrating a generation relationship of δ_{f} due to a difference between left and right longitudinal forces upon differential braking as a steering geometry model according to an exemplary embodiment of the present disclosure.

FIG. 5 is graphs showing comparison of a real vehicle according to a negative scrub radius (−20 mm) and a simulation result according to an exemplary embodiment of the present disclosure.

FIG. 6 is graphs showing comparison of a real vehicle according to a positive scrub radius (+20 mm) and a simulation result according to an exemplary embodiment of the present disclosure.

FIG. 7 is graphs for showing a speed of each scenario according to an exemplary embodiment of the present disclosure.

FIG. 8 is graphs for showing a wheel braking torque of each scenario according to an exemplary embodiment of the present disclosure.

FIG. 9 is graphs for showing a vehicle steering angle of each scenario according to an exemplary embodiment of the present disclosure.

FIG. 10 is graphs showing a yaw rate and a wheel speed of a vehicle according to a negative scrub radius (−20 mm) scenario (A_1, B_1) according to an exemplary embodiment of the present disclosure.

FIG. 11 is graphs showing a yaw rate and a wheel speed of a vehicle according to a positive scrub radius (+20 mm) scenario (A_2,3,4, B_2,3,4) according to an exemplary embodiment of the present disclosure.

FIG. 12A is a flowchart for showing a method for controlling a brake system without considering an external factor according to an exemplary embodiment of the present disclosure.

FIG. 12B is a flowchart for showing a method controlling a brake system by considering an external factor according to an exemplary embodiment of the present disclosure.

### DETAILED DESCRIPTION

In the following detailed description, reference is made to the accompanying drawing, which forms a part hereof. The illustrative embodiments described in the detailed description, drawing, and claims are not meant to be limiting. Other embodiments may be utilized, and other changes may be made, without departing from the spirit or scope of the subject matter presented here.

Hereinafter, exemplary embodiments of the present disclosure will be described in detail so as to be easily implemented by those skilled in the art, with reference to the accompanying drawings. The present disclosure may have various modifications and various exemplary embodiments and specific exemplary embodiments will be illustrated in the drawings and described in detail in the detailed description. However, this does not limit the present disclosure to specific exemplary embodiments, and it should be understood that the present disclosure covers all the modifications, equivalents and replacements included within the idea and technical scope of the present disclosure.

In this specification, ‘part’ or ‘module’ includes a unit realized by hardware or software, a unit realized using both directions, and one unit may be realized using two or more hardware, or two or more units may be realized by one hardware.

Hereinafter, an apparatus and a method for controlling a brake system according to some exemplary embodiments of the present disclosure will be described in detail with reference to the accompanying drawings.

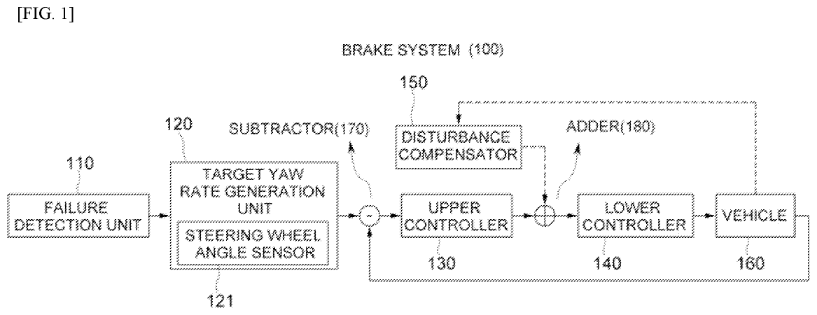

FIG. 1 is a block diagram illustrating a configuration of a brake system according to an exemplary embodiment of the present disclosure.

Referring to FIG. 1, a brake system 100 may include a failure detection unit 110, a target yaw rate generation unit 120, a steering wheel angle sensor 121, an upper controller 130, a lower controller 140, a disturbance compensator 150, and a vehicle 160. The brake system 100 may further include a subtractor 170 and an adder 180. The failure detection unit 110, the target yaw rate generation unit 120, the upper controller 130, the lower controller 140, and the disturbance compensator 150 may be implemented by one or more memories configured to store computer executable instructions and/or one or more processors configured to execute the computer executable instructions stored in the memory.

The failure detection unit 110 detects whether a wheel steering actuator operably and mechanically connected to vehicle wheels for steering the vehicle wheels does not receive a signal associated with a driver's manipulation to a steering wheel or a signal for controlling the wheel steering actuator from an electronic control unit (ECU)) due to a failure in communication in a steer-by-wheel (SbW) system. The failure detection unit 110 may include various sensors or devices capable of detecting the communication failure, such as a failure detection sensor, a communication interface, a signal processing means, a warning device, etc.

The target yaw rate generation unit 120 generates a control target of a target yaw rate \dot{ψ}^{des}. Specifically, a steering wheel angle sensor 121 mounted on a steering feedback actuator (SFA) operably and mechanically connected to a steering wheel may normally measure the driver's manipulation to a steering wheel even in case of the failure in the SbW system. That is, the control target of the target yaw rate \dot{ψ}^{des} can be generated based on a manipulation amount of the steering wheel by the driver sensed by the steering wheel angle sensor 121. Additionally, when an autonomous driving or an driver-assistance system (DAS) is performed, the control target of the target yaw rate \dot{ψ}^{des} can be generated based on a control amount of a steering angle which keeps a lane or needs to change the traffic lane.

The upper controller 130 calculates a control input of a target differential force F_{DB}^{des} which can reduce or minimize an error between the control target and a vehicle state through state-feedback control. Preferably, the operation of calculating the control input of the target differential force F_{DB}^{des} can be performed by the upper controller 130 in real time.

Meanwhile, a control input value of the target differential force F_{DB}^{des} may not be sufficient due to other external factors such as road surface friction, slope, temperature, altitude, vehicle load, tire condition, traffic situation, etc. The external factor may adopt, for example, but not limited to, a normal road surface condition (a friction coefficient of 0.9 or more) and a flatland (a slope of 0). In order to reflect such an external factor or influence to the control of steering, the disturbance compensator 150 derives a compensated differential force F_{DB}^{com} and compensates for the derived compensated differential force F_{DB}^{com} with the target differential force F_{DB}^{des} to calculate a final differential force F_{DB}^{final}.

The lower controller 140 converts the final differential force F_{DB}^{final} derived by the upper controller 130 into a braking torque for each of vehicle wheels (e.g., front-left, front-right, rear-left and rear-right wheels), and a brake system (e.g., an integrated dynamic brake (IDB) system) distributes a braking pressure to caliper actuators so that the braking torque for each wheel may be generated. When a wheel slip occurs during the control in case of safety, an anti-lock brake system (ABS) and an electronic stability control (ESC) logic in the IDB may be executed.

Hereinafter, an operation of the upper controller 130 according to an embodiment of the present disclosure will be described in more detail.

Even when a road wheel actuator (RWA) operably and mechanically connected to road wheels for steering the road wheels is not normally operated due to the failure of the SbW system, a driver wants to drive the vehicle in a desired direction by manipulating a steering wheel. This means that a yaw behavior of the vehicle required by the driver or corresponding to an input of the driver should be simulated by or as the differential braking control. That is, a yaw rate of the vehicle when normal steering is performed while driving is regarded as an SbB control target yaw rate \dot{ψ}^{des}, and this is determined by a driving speed and a steering manipulation amount of the driver. The steering manipulation amount δ^{sw} can be measured by steering wheel angle sensor (SAS).

In an embodiment of the present disclosure, a yaw rate estimated according to the driving speed and the steering manipulation amount may be selected or estimated target yaw rate \dot{ψ}^{des} through a 2-degree of freedom (DOF) transverse vehicle dynamics model as in Equation 1 below.

$$\ddot{y} = - \frac{{C}_{a f} + {C}_{ar}}{m {V}_{x}} \dot{y} + \{ - {V}_{x} - \frac{{l}_{f} {C}_{af} - {l}_{r} {C}_{ar}}{m {V}_{x}} \} {\dot{ψ}}^{des} + \frac{{C}_{af}}{m \cdot r} {δ}^{SW} \qquad ( Equation 1 )$$

$$\ddot{ψ} = - \frac{2 {l}_{f} {C}_{af} - 2 {l}_{r} {C}_{ar}}{{I}_{z} {V}_{x}} \dot{y} + \{ - \frac{2 {l}_{f}^{2} {C}_{af} + 2 {l}_{r}^{2} {C}_{ar}}{{I}_{z} {V}_{x}} \} \dot{ψ} + \frac{2 {l}_{f} {C}_{af}}{{I}_{z}} {δ}^{SW}$$

$${\dot{ψ}}^{des} = \int \ddot{ψ}$$

Where, δ^{zw} represents a steering wheel angle, C_{af} and Cₐᵣ represent cornering rigidities of the front wheel and the rear wheel, respectively, l_{f} represents a distance to a front wheel axis from the center of the vehicle, lᵣ represents a distance to a rear wheel axis from the center of the vehicle, I_{z} represents an inertia moment of the vehicle with respect to a z axis, m represents a mass of the vehicle, Vₓ represents the driving speed of the vehicle, each of ÿ and \dot{y} represents a transverse acceleration, r represents a proportional coefficient, and \dot{ψ}_{des} represents the target yaw rate.

Equation 1 is configured by a simultaneous differential equation, and \ddot{ψ} are ÿ calculated by inputting δ^{zw} and Vx are integrated and substituted into Equation 1 above to estimate final \dot{ψ}. Meanwhile, a method of estimating the target yaw rate \dot{ψ}^{des} is not limited to a method using the 2-DOF transverse vehicle dynamics model, and any method for estimating the target yaw \dot{ψ}^{des} rate can be used. For example, a method for generating a yaw rate generated by manipulating an actual test vehicle through a real vehicle test as a map may also be used.

Hereinafter, a 3-DOF transverse vehicle dynamics model design applied to the upper controller 130 will be described. The control input F_{DB}^{des} which reaches the control target \dot{ψ}^{dez} prioritizes the dynamic model design of the vehicle. Since the conventional transverse vehicle dynamics model focuses only on a transverse behavior (e.g. transverse movement distance, or yaw), the conventional transverse vehicle dynamics model follows that longitudinal attributes such as the driving speed and the acceleration are constant. In addition, in the conventional transverse vehicle dynamics, a horizontal differential braking force influence is not also reflected. However, when the SbB control is performed, the influence of the transverse behavior due to the horizontal differential braking force and a deceleration due to the braking force also need to be considered. Therefore, unlike the conventional transverse vehicle dynamics, in some embodiments of the present disclosure, a longitudinal element may be reflected to the transverse vehicle dynamics model to use the 3-DOF transverse vehicle dynamics model as in Equation 2 below.

$$m ( \ddot{y} + \dot{x} \dot{ψ} ) = {F}_{yf} + {F}_{xf} \cdot {δ}_{f} + {F}_{y r} \qquad ( Equation 2 )$$

$${I}_{z} \ddot{ψ} = {l}_{f} \cdot {F}_{yf} + {l}_{f} \cdot {F}_{xf} \cdot {δ}_{f} - {l}_{r} {F}_{y r} - \frac{D}{2} ( {F}_{x \_ L} - {F}_{x \_ R} )$$

Accordingly, Fx_L=F_{xfL}+F_{xrL}, Fx_R=F_{xfR}+F_{xrR}. Further, F_{xfL}−F_{xfR}=ΔF_{xf}, F_{xrL}−F_{xrR}=ΔFₓᵣ may be derived from Equation 2.

Other forces are represented in Equation 3 below.

$${F}_{y f} = 2 \cdot {C}_{α f} \cdot {α}_{f} where {α}_{f} = {δ}_{f} - {θ}_{f} \qquad ( Equation 3 )$$

$${F}_{y r} = 2 \cdot {C}_{α r} \cdot {α}_{r} where {α}_{r} = - {θ}_{r}$$

$${F}_{x f} = m \cdot {a}_{w f} where {a}_{w f} = {r}_{e f f} \cdot \dot{{ω}_{w}}$$

Where, r_{eff} represents an effective tire radius of a vehicle wheel and \dot{ω}_{w} means a rotational wheel acceleration. Velocity angles θ_{f} and θᵣ may be estimated by using Equation 4 below.

$${θ}_{f} ≃ ( \dot{y} + {l}_{f} \dot{ψ} ) / \dot{x} \qquad ( Equation 4 )$$

$${θ}_{r} ≃ ( \dot{y} - {l}_{r} \dot{ψ} / \dot{x}$$

Equations 3 and 4 are applied into Equation 2, and organized as state variables \dot{y} and \dot{ψ}, which is shown in Equation 5 below.

$$\ddot{y} = \frac{- 2 ( {C}_{α f} + {C}_{α r} )}{m \dot{x}} \dot{y} + \{ - 1 - \frac{2 ( {C}_{α f} {l}_{f} - {C}_{α r} {l}_{r} )}{m {\dot{x}}^{2}} \} \dot{x} \dot{ψ} + ( \frac{2 {C}_{α f} + {mr}_{eff} {\dot{ω}}_{w}}{m} ) {δ}_{f} - 2 ( {C}_{α f} {l}_{f} - {C}_{α r} {l}_{r} ) - 2 ( {C}_{α f} {l}_{f}^{2} + {C}_{α r} {l}_{r}^{2} ) , \qquad ( Equation 5 )$$

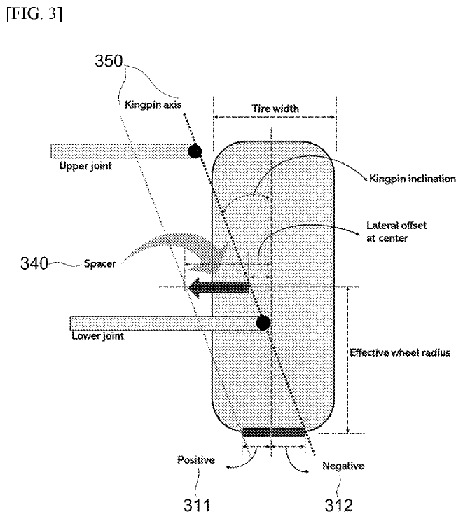

Since the steering angle δ_{f} is generated by the differential braking regardless of the manipulation of the driver in the case of the SbW failure, the steering angle δ_{f} may not be used as the control input. As described above, δ_{f} is naturally generated by the influence of the scrub radius between the tire and the ground upon differential braking, and a physical rotational direction of the wheel is determined by a sign of the value. That is, a vehicle yaw motion is generated in a direction in which the braking force is applied in the differential braking, and in this case, a δ_{f} relationship according to setting of the scrub radius, i.e., the steering mechanism geometry can be reflected to the dynamic model. The scrub radius according to the steering mechanism geometry design is illustrated in FIG. 3. The size and the sign of the scrub radius are determined by a slope of a king-pin axis 350, a side offset of a wheel center, and an effective wheel size. That is, the scrub radius means a distance to the center of the tire from a point where the king-pin axis 350 and the ground contact, and have negative (312) and positive (311) values as illustrated in FIG. 3. It may be advantageous that the wheel steering angle is generated in the same direction in which the differential braking is applied, e.g., the yaw moment is generated for the control. In certain embodiments of the present disclosure, an initially designed negative scrub radius can be changed to a positive scrub radius value by additionally mounting a spacer 340 between a vehicle wheel and a brake disk. In another exemplary embodiment of the present disclosure, the slope of the king-pin axis 350 may be changed.

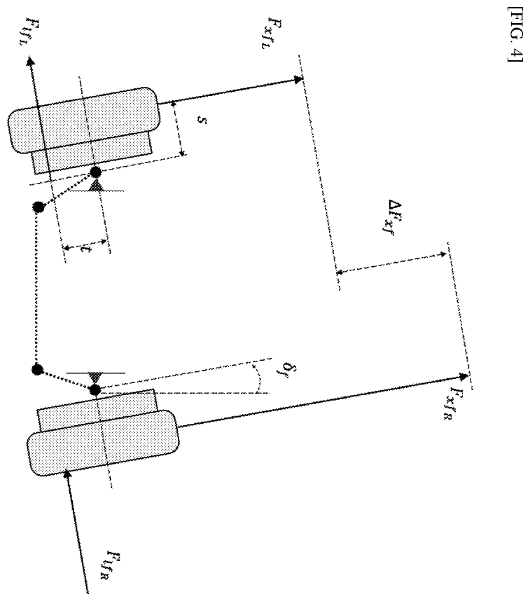

The δ_{f} generation relationship due to a horizontal longitudinal force difference upon the differential braking is schematized as a steering geometry model illustrated in FIG. 4, and Equation 6 may be derived based on the steering geometry model shown in FIG. 4.

$${δ}_{f} = β + \frac{{l}_{f}}{\dot{x}} \dot{ψ} - \frac{s}{2 {C}_{α f} \cdot t} Δ {F}_{x f} where β ≃ \frac{\dot{y}}{\dot{x}} \qquad ( Equation 6 )$$

Where, F_{xf_L} and F_{xf_R} mean left and right longitudinal forces, respectively, and ΔF_{xf} represents a difference between the forces. F_{yf_L} and F_{yf_R} mean left and right transverse forces, respectively, s means the scrub radius, and t means a mechanical trail due to a caster angle.

The steering geometry model of Equation 6 is applied to the 3-DOF transverse vehicle dynamic model of Equation 5, and this is expressed as a state space model equation as in Equation 7 below.

$$\frac{d}{dt} [ \begin{matrix}\dot{y} \\ \dot{ψ}\end{matrix} ] = [ \begin{matrix}\frac{- 2 {C}_{α r} + {mr}_{eff} {\dot{ω}}_{w}}{m \dot{x}} & \frac{2 {C}_{α r} {l}_{r} - m {\dot{x}}^{2} + {mr}_{eff} {\dot{ω}}_{w} {l}_{f}}{m \dot{x}} \\ \frac{2 {C}_{α r} {l}_{r} + {mr}_{eff} {\dot{ω}}_{w} {l}_{f}}{{I}_{z} \dot{x}} & \frac{- 2 {C}_{α r} {l}_{r}^{2} + {mr}_{eff} {\dot{ω}}_{w} {l}_{f}^{2}}{{I}_{z} \dot{x}}\end{matrix} ] [ \begin{matrix}\dot{y} \\ \dot{ψ}\end{matrix} ] + [ \begin{matrix}- \frac{( 2 {C}_{α f} + {mr}_{eff} {\dot{ω}}_{w} ) s}{2 {C}_{α f} mt} & 0 \\ - \{ \frac{2 {C}_{α f} {l}_{f} + {mr}_{eff} {\dot{ω}}_{w} {l}_{f} ) s}{2 {C}_{α f} {I}_{z} t} + \frac{D}{2 {I}_{z}} \} & - \frac{D}{2 {I}_{z}}\end{matrix} ] [ \begin{matrix}Δ {F}_{xf} \\ Δ {F}_{xr}\end{matrix} ] \qquad ( Equation 7 )$$

Where, the transverse speed y and \dot{y} and the yaw rate ψ and \dot{ψ} mean state variables, and ΔF_{xf}, and ΔFₓᵣ as left and right longitudinal force differences of the front wheel and the rear wheel, e.g., the differential braking forces mean control inputs.

In general, shapes of braking forces distributed to the front wheel and the rear wheel are similar upon vehicle braking, but in terms of the size of the braking force, a larger braking force is applied to the front wheel than the rear wheel. In this case, since a larger load is applied to the front wheel of the vehicle than the rear wheel by a pitch motion upon the braking, the larger braking force is applied to the front wheel than the rear wheel even when the same braking pressure is applied to the front wheel and the rear wheel by the IDB system. By reflecting this behavior of the vehicle, the differential braking force between the front wheel and the rear wheel may be represented as in Equation 8 below.

$$Δ {F}_{x f} = α Δ {F}_{x} , Δ {F}_{x r} = ( 1 - α ) Δ {F}_{x} \qquad ( Equation 8 )$$

Where, α represents a ratio of differential braking amounts applied to the front wheel and the rear wheel.

Finally, by applying Equation 8 to Equation 7, the 3-DOF transverse vehicle dynamic model may be represented as a single control input as in Equation 9.

$$\frac{d}{dt} [ \begin{matrix}\dot{y} \\ \dot{ψ}\end{matrix} ] = [ \begin{matrix}\frac{- 2 {C}_{α r} + {mr}_{eff} {\dot{ω}}_{w}}{m \dot{x}} & \frac{2 {C}_{α r} {l}_{r} - m {\dot{x}}^{2} + {mr}_{eff} {\dot{ω}}_{w} {l}_{f}}{m \dot{x}} \\ \frac{2 {C}_{α r} {l}_{r} + {mr}_{eff} {\dot{ω}}_{w} {l}_{f}}{{I}_{z} \dot{x}} & \frac{- 2 {C}_{α r} {l}_{r}^{2} + {mr}_{eff} {\dot{ω}}_{w} {l}_{f}^{2}}{{I}_{z} \dot{x}}\end{matrix} ] [ \begin{matrix}\dot{y} \\ \dot{ψ}\end{matrix} ] + [ \begin{matrix}α \{ - \frac{( 2 {C}_{α f} + {mr}_{eff} {\dot{ω}}_{w} ) s}{2 {C}_{α f} mt} \} \\ - α \{ \frac{( 2 {C}_{α f} {l}_{f} + {mr}_{eff} {\dot{ω}}_{w} {l}_{f} ) s}{2 {C}_{α f} {I}_{z} t} + \frac{D}{2 {I}_{z}} \} - ( 1 - α ) \frac{D}{2 {I}_{z}}\end{matrix} ] [ Δ {F}_{x} \qquad ( Equation 9 )$$

According to an exemplary embodiment of the present disclosure, a pole-placement control technique may be applied in order to derive an upper control input F_{DB}^{des}. A state-feedback control input in the state space model represented by Equation 9 may be represented by Equation 10 below.

$${F}_{DB}^{des} = Δ {F}_{x} = U ( k ) = - K \cdot X \qquad ( Equation 10 )$$

In this case, a state equation of a closed-loop system is represented as in Equation 11 below.

$$\dot{X} ( t ) = ( A - BK ) X ( t ) \qquad ( Equation 11 )$$

Stability and excessive response characteristics of the closed-loop system are determined by eigen values of (A−BK), which are calculated through a characteristic equation of Equation 12 below.

$$det [ λ I - A + B K ] = {λ}^{n} + {a}_{n - 1} {λ}^{n - 1} + {a}_{n - 2} {λ}^{n - 2} + … + {a}_{n} \qquad ( Equation 12 )$$

Here, Equation 12 may be organized as in Equation 13 below through the Cayley-Hamilton theorem that satisfies the unique characteristic equation.

$$φ [ ( A - BK ) ] = {( A - BK )}^{n} + {{a}_{1} ( A - B K )}^{n - 1} + {a}_{n - 1} ( A - B K ) + {a}_{n - 1} I = 0 \qquad ( Equation 13 )$$

Equation 12 is substituted and organized by developing Equation 13, which is shown as in Equation 14 below.

$$φ ( A ) = < \vert AB \vert … \vert {A}^{n - 1} > ( \begin{matrix}\begin{matrix}\begin{matrix}{a}_{n - 1} K + … + {a}_{1} {K ( A - BK )}^{n - 2} + {K ( A - BK )}^{n - 1} \\ ⋮\end{matrix} \\ {a}_{1} K + K ( A - BK )\end{matrix} \\ K\end{matrix} ) \qquad ( Equation 14 )$$

Since the system can be subjected to complete state control, there is a reverse matrix of a controllability matrix, and both sides are multiplied by [0 0 . . . 0 1] to organize a control gain K as in Equation 15 below.

$$K = [ 00 … 01 ] < B \vert AB \vert … \vert {A}^{n - 1} B {>}^{- 1} φ ( A ) \qquad ( Equation 15 )$$

If the system is able to be controlled, a control gain K may be selected, which may place eigen values of the closed loop system (A−BK) at an appropriate location. That is, it is necessary to place a dominant pole at a preferable location by considering a settling time, a maximum over shoot, etc., for satisfactory performance of a controller. For example, the state space equation is n=2, and K is obtained through two poles, and is substituted into Equation 10 to derive the control input F_{DB}^{des}.

When there is no longitudinal control while the SbB control is performed, the driving speed of the vehicle is reduced, and this means that system matrices A and B of the state space equation are variable. When the system matrices are rapidly changed, it is difficult to fully secure the control stability, but it is possible to sufficiently cope with a case where a certain change is shown in some degree as in the exemplary embodiment of the present disclosure, and the pole is appropriately relocated by setting a section to secure control performance.

In an exemplary embodiment of the present disclosure, in order to reflect a longitudinal dynamic behavior, a longitudinal speed \dot{x} and a wheel speed \dot{ω}_{w} measured in real time are adapted to the system matrix to derive the control input. As an exemplary embodiment of the present disclosure, when F_{DB}^{com} of a control input compensation part is not applied, F_{DB}^{des} is set as the final control input F_{DB}^{final}.

The lower controller 140 converts the final control input F_{DB}^{final} derived by the upper controller 130 into braking torques and pressures of front-left, front-right, rear-left and rear-right wheels, and distributes the braking torques and pressures to the braking actuators of the respective wheels. The final control input F_{DB}^{final} is multiplied by a gain Kₚᵣ in order to convert the final control input F_{DB}^{final} into brake torques. When a value of the final control input F_{DB}^{final} is a positive number, the braking torques may be applied to the front-left and rear-left wheels, and when the value of the final control input F_{DB}^{final} is a negative number, the braking torques may be applied to the front-right and rear-right wheels. Here, the braking torques are distributed to the front wheel and the rear wheel equally to the α ratio of Equation 8, and set based on a wheel torque factor calculated based on a wheel size, a brake disk, and a caliber pressure attribute of each of the front wheel and the rear wheel of a test vehicle.

According to an exemplary embodiment of the present disclosure, the test vehicle (Genesis G80 EV) is designed to have a wheel torque distribution of 66.5% for the front wheel and 33.5% for the rear wheel in order to apply the same braking pressure to front and rear-wheel calipers. Designing or setting the brake pressure distribution to apply the same amount or magnitude of pressure to the front and rear wheels may be more advantageous for securing the stability of the braking control. When an excessive braking pressure is applied, a wheel lock may occur, and in order to prevent such a problem, a saturation state is made by a pressure of approximately 80 bar as much as possible each wheel. A finally calculated braking pressure of each wheel is applied through the IDB system of the test vehicle in real time. When the wheel slip additionally occurs, an ABS control may be performed.

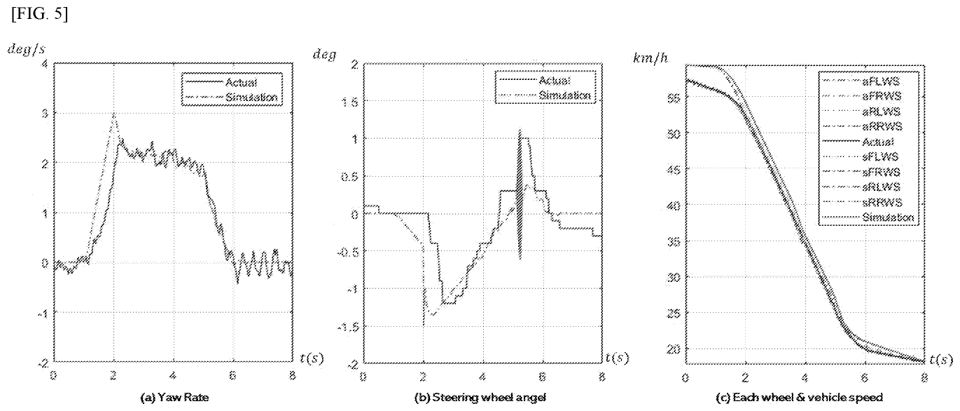

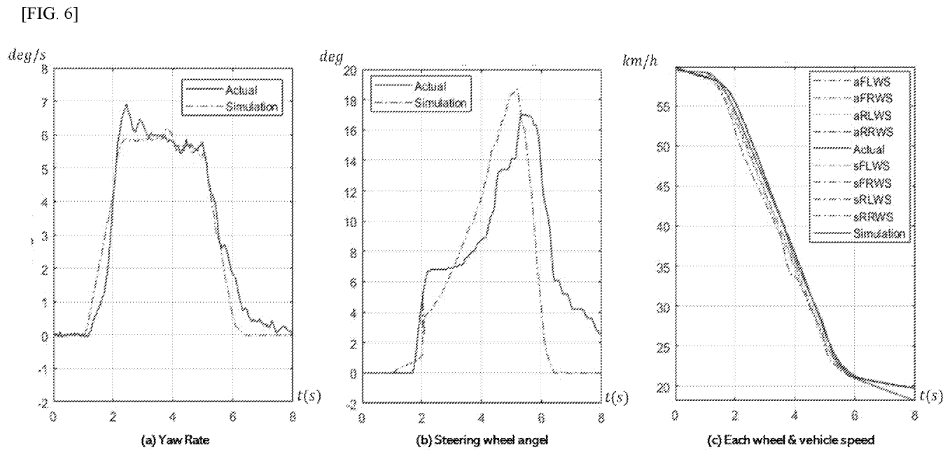

FIGS. 5 and 6 illustrate two examples of comparing a simulation and an on-vehicle test result according to an exemplary embodiment of the present disclosure after completing simulation parameter calibration. FIGS. 5 and 6 are different only in terms of scrub radius setting of ±20 mm, and are the same as each other in terms of all of the remaining conditions including an initial speed of approximately 60 km/h, front-left and rear-left wheel brake pressures of 50 bar, a free rolling state based wheel angle, and there is no wheel driving force. Here, FIGS. 5(a) and 6(a) illustrate the yaw rate measured at the center of the vehicle, and in FIGS. 5(b) and 6(b), the angle of the front wheel may be measured instead of the angle of the steering wheel. In addition, FIGS. 5(c) and 6(c) illustrate each wheel and the vehicle speed. Here, aFLWS means Actual Front Left Wheel Speed and sFLWS means Simulated Front Left Wheel Speed, and those are represented by different wheel speeds. Here, “actual” represents a driving speed of an actual test vehicle and “simulated” represents a driving speed of a simulation vehicle. It is noteworthy in this test, which can be seen in FIGS. 5(b) and 6(b) as a generation direction relationship of the wheel angle according to the scrub radius setting upon the differential braking. In negative scrub radius setting, there is a tendency of generating the wheel angle opposite to a direction in which the differential braking is applied. Even though the same differential braking pressure is applied in two exemplary embodiments, a maximum yaw rate value difference of approximately three times is generated in a case that the yaw rate is 2 deg/s in the negative setting and 6 deg/s in the positive setting. Accordingly, the test shows that it is advantageous for controlling the SbB system in the positive scrub radius structure.

Table 1 below shows an evaluation scenario according to an exemplary embodiment of the present disclosure.

TABLE 1

| Scenario | | Initial | Scrub | Cruise |
|---|---|---|---|---|
| description | Scenario no. | speed (kph) | radius (mm) | control |
| A. Lane keeping | A_1 | 60 | −20 | No |
| in curved road | A_2 | 60 | +20 | No |
| (R: ∞ - 4 m - ∞) | A_3 | 80 | +20 | No |
| | A_4 | 60 | +20 | Yes |
| B. Lane changing in | B_1 | 60 | −20 | No |
| straight road | B_2 | 60 | +20 | No |
| | B_3 | 80 | +20 | No |
| | B_4 | 60 | +20 | Yes |

Since the SbB system is developed for a purpose of coping with the SbW system failure, the evaluation is performed in a steering of keeping the lane in a curvature change in case of occurrence of the failure (scenario A) and a lane changing steering for stopping on a shoulder in a straight road (scenario B).

In a test scenario of Table 1, two settings of the negative and positive scrub radius (mounting the spacer) are considered. Further, two speeds of approximately 60 and 80 km/h are set for the initial driving speed, and the evaluation is performed in a total of 8 scenarios by considering a case where the vehicle slowly stops by stopping the driving force control of the wheel at the time of performing the SbB control and a case where an acceleration control for keeping a cruise control is performed simultaneously.

By considering the on-vehicle test, the controller is set or designed to be repeatedly performed in units of 0.001 second based on a discrete time signal. In all scenarios, for initial 5 seconds as a warm-up time, cruise control is performed, and since then, the SbB control is executed.

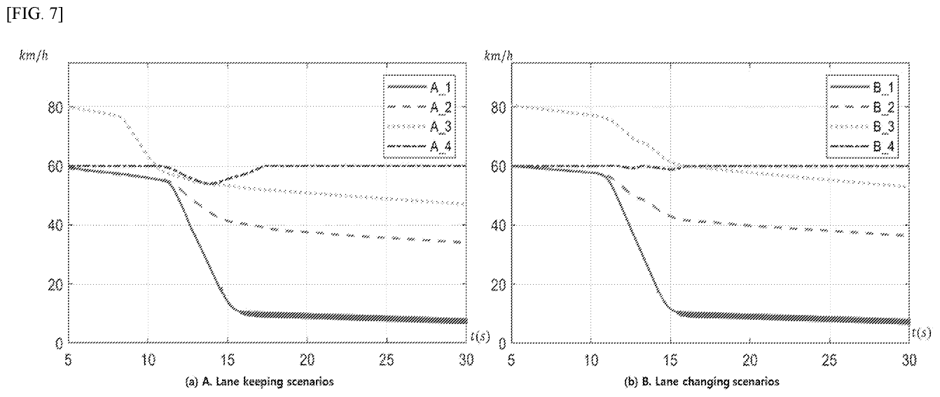

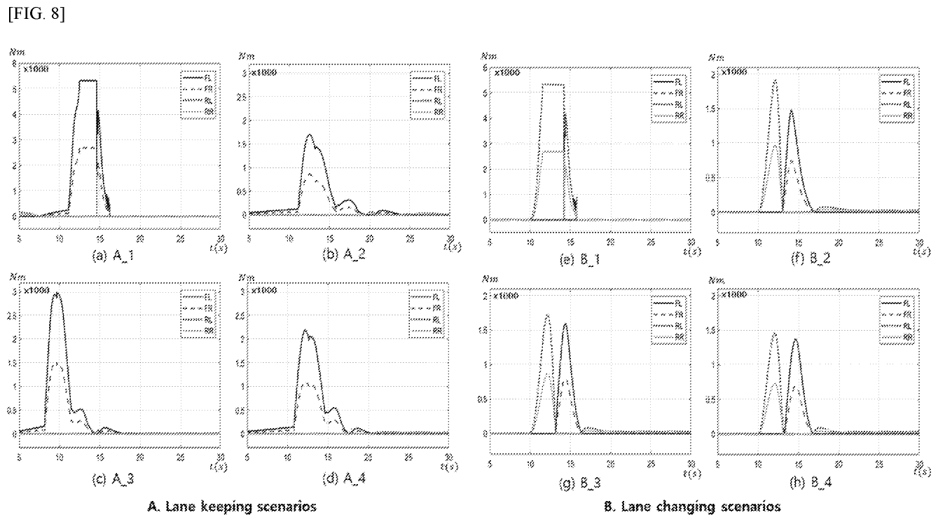

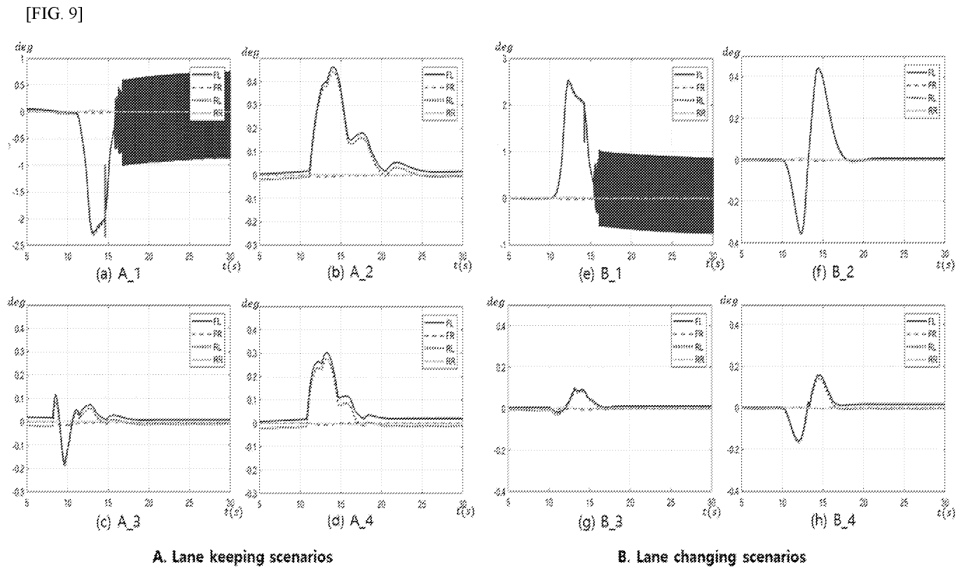

FIG. 7 is graphs for showing a speed of each scenario and FIG. 8 is graphs for illustrating each wheel brake torque which is a control input calculated through the SbB controller for each scenario. Further, FIG. 9 are graphs in which a measurement log of each wheel angle for each scenario is organized.

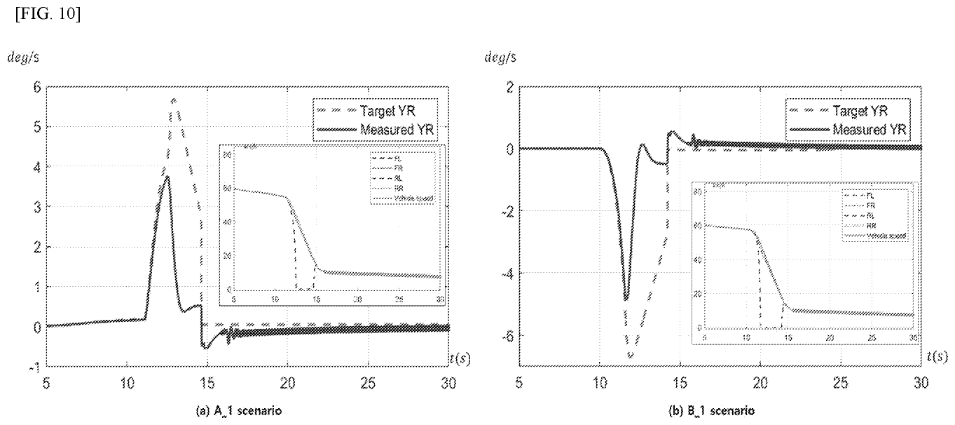

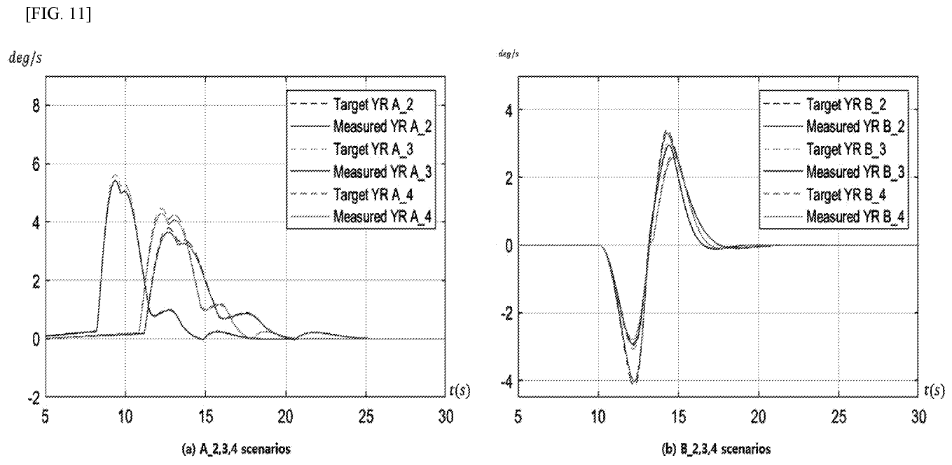

A target yaw rate and an actual vehicle yaw rate and speeds of respective wheels in scenarios A_1 and B_1 are illustrated in FIGS. 10(a) and 10(b). Comparison graphs of yaw rates in scenarios A_2,3,4 and B_2,3,4 are shown in FIGS. 11(a) and 11(b).

In scenarios A_1 and B_1 of the negative scrub radius setting of −20 mm, the wheel angle of the front wheel is generated as approximately 2.5 deg. Contrary to the generation of a yaw moment upon the SbB control as in FIGS. 9(a) and 9(b), and this may exert a bad influence on turning of the vehicle. As in FIGS. 10(a) and 10(b), the target yaw rate is not fully satisfied and a wheel lock occurs, and even though an excessive braking torque of 5000 Nm (approximately 80 bar) or more is applied to FL (a front-left wheel) as the control input as in FIGS. 8(a) and 8(e) in order to reach the target yaw rate, it can be seen that a control target yaw rate is not reached. Moreover, the yaw rate is rapidly reduced compared with the positive scrub radius scenario by a deceleration of approximately 2.8 m/s 2 (see FIG. 7), and such a driving force lowering influence leads to generate an insufficient yaw rate. Further, in FIGS. 9(a) and 9(e), a phenomenon in which the wheel angle vibrates at approximately −1 to 1 degree around approximately 17 seconds is shown, and this may be regarded as an error which occurs due to simulation setting to which free rolling is reflected at a lower speed of 10 km/h or less.

FIGS. 11(a) and 11(b) show that scenarios A_2,3,4 and B_2,3,4 of positive scrub radius setting of +20 mm reache the target yaw rate. FIGS. 8(b), 8(c), 8(d), 8(f), 8(g), and 8(h) show that in order to follow the target yaw rate, an appropriate braking torque of approximately 2700 Nm or less is applied to each wheel of a turning direction as the control input. It is seen that the wheel angle of the front wheel is also generated in the same direction as a differential braking turning direction due to a positive scrub radius effect in spite of a free rolling condition.

In particular, the influence of the positive scrub radius is noteworthy at a high speed of 80 km/h or more. FIGS. 9(c) and 9(g) show that an influence in which the wheel angle of the front wheel is angled slightly opposite to the differential braking direction. However, thereafter, the speed is reduced and the wheel angle is slowly generated in the same direction as the turning direction, and the availability of the SbB control is secured. In all scenarios of the positive scrub radius setting according to the test performed based on an exemplary embodiment of the present disclosure, there is no case where the wheel lock occurs, and complete control stability can be secured. Further, in the case of scenarios A_4 and B_4 of FIG. 7 in which driving force of keeping the initial driving speed is applied, sufficient SbB control performance can be also secured, and the speed is slightly reduced due to the differential braking control, but an initial setting speed can be reached shortly.

The SbB system according to some embodiment of the present disclosure can cope with the failure of the SbB system using the differential braking control performed in response to the control of a steering angle of a driver's manipulation when the steering is disabled due to the SbW system failure. According to certain embodiments of the present disclosure, it is possible to sufficiently or appropriately cope with a steering disabling situation through system evaluation of various scenarios.

In some embodiments of the present disclosure, the control availability may be effectively secured only in the positive scrub radius setting. However, by applying the configuration of certain embodiments of the present disclosure, even in the negative scrub radius steering system applied to most vehicles mass-produced through various integrated chassis control attempts, the negative scrub radius can be changed to the positive scrub radius to secure the control availability. For example, when a front wheel vehicle height (e.g. a king-pin angle) is adjusted by integrating with a variable suspension control in the case of the SbW system failure, the negative scrub radius may be changed to the positive scrub radius. Moreover, when the integration with a rear wheel steering (RWS) control system, the addition of the driving force, and the distribution of the driving force are actively utilized, it is possible to sufficiently overcome a structural limitation of the negative scrub radius.

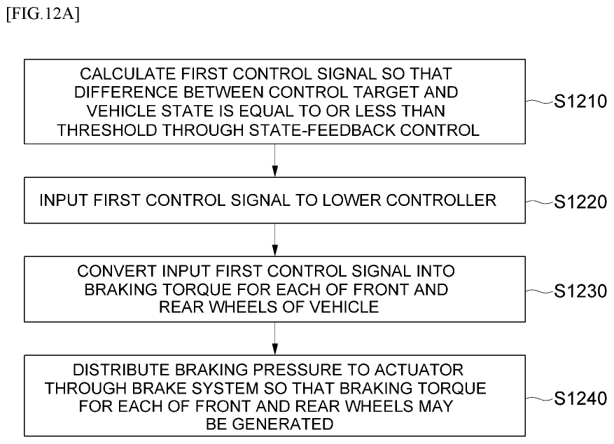

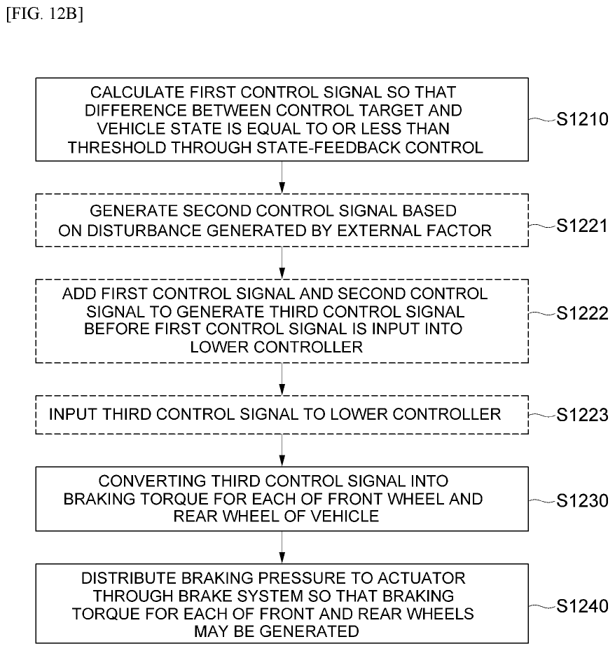

FIG. 12A is a flowchart for showing a method for controlling a brake system without considering an external factor according to an embodiment of the present disclosure and FIG. 12B is a flowchart for showing a method controlling a brake system by considering an external factor according to an embodiment of the present disclosure.

Referring to FIG. 12A, in step S1210, the upper controller 130 generates a first control signal for controlling a difference between a control target and a vehicle state to be equal to or less than a threshold through state-feedback control. Here, preferably, the threshold can be set to be a maximum allowable value of the difference between the control target and the vehicle state. Alternatively, it is also possible to set the control target and the vehicle state to be equal to each other. Moreover, in step S1210, it is preferable to calculate the first control signal in real time.

For example, the control target may include the target yaw rate, and the target yaw rate means a yaw rate of the vehicle when the steering is performed in a normal situation during the driving of the vehicle. Here, the target yaw rate may be determined by using a yaw rate map generated by collecting data from yaw rates generated during the manipulation of the actual test vehicle, and determined according to the driving speed and the steering manipulation amount through the 2-DOF transverse vehicle dynamics model.

In step S1210, the state-feedback control may adopt a state space model in which the steering geometry model is applied to the 3-DOF wheel direction vehicle dynamic model, and by applying a longitudinal element to the 2-DOF transverse vehicle dynamics model, the negative scrub radius value may be changed to the positive scrub radius value. Further, the first control signal may become a state-feedback control input in the state space model, and in the state-feedback control input, a control gain K may be determined by placing a representative pole at a location where the control stability is secured.

In step S1220, the first control signal generated in step 1210 may be input into the lower controller 140. When a value of a final control input F_{DB}^{final} (e.g., a value of the first control signal not considering the external factor) input into the lower controller 140 is a positive number, a braking torque may be applied to front-left and front-rear wheels, and when the value of the final control input F_{DB}^{final} is a negative number, the braking torque may be applied to front-right and rear-right wheels. Here, the braking torques are distributed to the front wheel and the rear wheel equally to the α ratio of Equation 8 described above, and may be set based on a wheel torque factor calculated based on a wheel size, a brake disk, and a caliber pressure attribute of each of the front wheel and the rear wheel of a test vehicle.

In step 1230, the lower controller 140 converts the first control signal into braking torques for each of the front and rear wheels of the vehicle, and distributes a braking pressure to actuators through a brake system so that the braking torque for each wheel may be generated in step S1240. The brake system, for example, but not limited to, an integrated dynamic brake (IDB) system, may distribute the braking pressure to a caliper actuator. Further, when a wheel slip occurs during the control in case of safety, an anti-lock brake system (ABS) and an electronic stability control (ESC) logic in the IDB may also be executed.

FIG. 12B illustrates another exemplary embodiment of the present disclosure considering an external factor.

In step S1221, a disturbance compensator 150 may generate a second control signal based on a disturbance generated by the external factor. The external factor may include, for instance, but not limited to, at least one of road surface friction, slope, temperature, altitude, vehicle load, tire condition, and traffic situation.

When the second control signal is generated by the disturbance compensator 150 in step S1222, an adder 180 adds the first control signal and the second control signal to generate a third control signal before the first control signal is input into the lower controller 140.

In step S1223, the third control signal in which the first control signal and the second control signal are combined is input into the lower controller 140 as a control input of the lower controller 140. Here, when a value of a final control input F_{DB}^{final} (e.g., a value of the third control signal considering the external factor) input into the lower controller 140 is a positive number, a braking torque may be applied to front-left and rear-left wheels, and when the value of the final control input F_{DB}^{final} is a negative number, the braking torque may be applied to front-right and rear-right wheels. Here, the braking torques are distributed to the front wheel and the rear wheel equally to the α ratio of Equation 8 described above, and may be set based on a wheel torque factor calculated based on a wheel size, a brake disk, and a caliber pressure attribute of each of the front wheel and the rear wheel of a test vehicle.

The exemplary embodiments according to the present disclosure may be stored in a computer readable storage medium and executed by a computing system including at least one processor and memory. An example of the computer readable storage medium may include magnetic media, such as a hard disk, a floppy disk, and a magnetic tape, optical media such as a CD-ROM and a DVD, magneto-optical media such as a floptical disk, and hardware devices such as a ROM, a RAM, and a flash memory, which are specially configured to store and execute the program command. An example of the program command includes a high-level language code executable by a computer by using an interpreter and the like, as well as a machine language code created by a compiler.

The aforementioned description of the present disclosure is used for exemplification, and it can be understood by those skilled in the art that the present disclosure can be easily modified in other detailed forms without changing the technical spirit or requisite features of the present disclosure.

The scope of the present disclosure is represented by claims to be described below rather than the detailed description, and it is to be interpreted that the meaning and scope of the claims and all the changes or modified forms derived from the equivalents thereof come within the scope of the present disclosure.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. An apparatus for controlling a brake system, the apparatus comprising:
one or more controllers configured to:
generate a first control signal for controlling a difference between a control target and a vehicle state to be equal to or less than a threshold through state-feedback control; and
convert the first control signal into braking torques for wheels including front-left, front-right, rear-left and rear-right wheels, and distribute a braking pressure to actuators of the wheels through the brake system to generate the braking torques for the front-left, front-right, rear-left and rear-right wheels.

2. The apparatus of claim 1, wherein the one or more controllers are configured to:
generate a second control signal based on a disturbance generated by an external factor;
generate a third control signal by adding the first control signal and the second control signal;
when a value of the third control signal is a positive number, apply the brake torques to the front-left and rear-left wheels; and
when the value of the third control signal is a negative number, apply the brake torques to the front-right and rear-right wheels.

3. The apparatus of claim 1, wherein
the control target includes a target yaw rate which is a yaw rate of a vehicle when steering is performed in a normal state during driving of the vehicle.

4. The apparatus of claim 3, wherein the target yaw rate is determined by using a yaw rate map generated by collecting data from yaw rates generated according to manipulation of the vehicle.

5. The apparatus of claim 3, wherein the target yaw rate is determined according to a driving speed of the vehicle and an amount of steering manipulation using a 2-degree of freedom (DOF) transverse vehicle dynamics model.

6. The apparatus of claim 1, wherein the state-feedback control uses a state space model in which a steering geometry model is applied to a 3-DOF transverse vehicle dynamics model.

7. The apparatus of claim 6, wherein:
a longitudinal element of the steering geometry model is applied to the 3-DOF transverse vehicle dynamics model,
in the 3-DOF transverse vehicle dynamics model, a size and a sign of a scrub radius are determined by a slope of a king-pin axis, a horizontal offset of a wheel center, and an effective wheel size, and
a value of the scrub radius is applied by changing a negative scrub radius value to a positive scrub radius value by mounting a spacer between one of the wheels and a brake disk or changing the slope of the king-pin axis.

8. The apparatus of claim 7, wherein the state space model in which the steering geometry model is applied to the 3-DOF transverse vehicle dynamics model is configured to use Equation 1.
$$\frac{d}{dt} [ \begin{matrix}\dot{y} \\ \dot{ψ}\end{matrix} ] = [ \begin{matrix}\frac{- 2 {C}_{α r} + {mr}_{eff} {\dot{ω}}_{w}}{m \dot{x}} & \frac{2 {C}_{α r} {l}_{r} - m {\dot{x}}^{2} + {mr}_{eff} {\dot{ω}}_{w} {l}_{f}}{m \dot{x}} \\ \frac{2 {C}_{α r} {l}_{r} + {mr}_{eff} {\dot{ω}}_{w} {l}_{f}}{{I}_{z} \dot{x}} & \frac{- 2 {C}_{α r} {l}_{r}^{2} + {mr}_{eff} {\dot{ω}}_{w} {l}_{f}^{2}}{{I}_{z} \dot{x}}\end{matrix} ] [ \begin{matrix}\dot{y} \\ \dot{ψ}\end{matrix} ] + [ \begin{matrix}α \{ - \frac{( 2 {C}_{α f} + {mr}_{eff} {\dot{ω}}_{w} ) s}{2 {C}_{α f} mt} \} \\ - α \{ \frac{( 2 {C}_{α f} {l}_{f} + {mr}_{eff} {\dot{ω}}_{w} {l}_{f} ) s}{2 {C}_{α f} {I}_{z} t} + \frac{D}{2 {I}_{z}} \} - ( 1 - α ) \frac{D}{2 {I}_{z}}\end{matrix} ] [ Δ {F}_{x} ] \qquad ( Equation 1 )$$
where, C_{af} and Cₐᵣ represent cornering rigidities of the front-left and front-right wheels and the rear-left and rear-right wheels, respectively, l_{f} represents a distance to a front wheel axis from a center of the vehicle, lᵣ represents a distance to a rear wheel axis from the center of the vehicle, m represents a mass of the vehicle, r_{eff} represents an effective tire radius, \dot{ω}_{w} represents a rotational wheel acceleration, ÿ represents a transverse acceleration, \dot{y} represents a transverse speed, r represents a proportional coefficient, I_{z} represents an inertial moment of the vehicle with respect to a vertical axis, ΔF_{xf} represents a difference between left and right longitudinal forces of the front-left and front-right wheels, and ΔFₓ represents a difference in longitudinal force.

9. The apparatus of claim 8, wherein the first control signal is an input of the state-feedback control in the state space model, and in the input of the state-feedback control, a control gain is determined by placing a representative pole at a location where control stability is secured.

10. The apparatus of claim 1, wherein the brake system includes at least one of an integrated dynamic brake (IDB) system, an anti-lock brake system (ABS) in the IDB, and an electronic stability control (ESC) logic.

11. A method for controlling a brake system, the method comprising:
generating, by an upper controller, a first control signal for controlling a difference between a control target and a vehicle state to be equal to or less than a threshold through state-feedback control;
inputting the first control signal to a lower controller;
converting, by the lower controller, the first control signal into braking torques for wheels of a vehicle including front-left, front-right, rear-left and rear-right wheels; and
distributing, by the lower controller, a braking pressure to actuators of the wheels through the brake system to generate the braking torques for the front-left, front-right, rear-left and rear-right wheels.

12. The method of claim 11, further comprising:
generating, by a disturbance compensator, a second control signal based on a disturbance generated by an external factor; and
adding, by an adder, the first control signal and the second control signal to generate a third control signal before the first control signal is input into the lower controller when the second control signal is generated by the disturbance compensator; and
inputting the third control signal to the lower controller.

13. The method of claim 11, wherein the control target includes a target yaw rate which is a yaw rate of the vehicle when steering is performed in a normal state during driving of the vehicle.

14. The method of claim 13, comprising:
determining the target yaw rate by using a yaw rate map generated by collecting data from yaw rates generated according to manipulation of the vehicle.

15. The method of claim 13, comprising:
Determining the target yaw rate according to a driving speed of the vehicle and an amount of steering manipulation using a 2-degree of freedom (DOF) transverse vehicle dynamics model.

16. The method of claim 11, wherein the state-feedback control uses a state space model in which a steering geometry model is applied to a 3-DOF transverse vehicle dynamics model.

17. The method of claim 16, wherein:
in the steering geometry model, a longitudinal element is applied to the 3-DOF transverse vehicle dynamics model, and
in the 3-DOF transverse vehicle dynamics model, a size and a sign of a scrub radius are determined by a slope of a king-pin axis, a horizontal offset of a wheel center, and an effective wheel size, and
the method further includes applying a value of the scrub radius by changing a negative scrub radius value to a positive scrub radius value by mounting a spacer between one of the wheels and a brake disk or changing the slope of the king-pin axis.

18. The method of claim 17, wherein:
the first control signal is an input of the state-feedback control in the state space model, and
in the input of the state-feedback control, a control gain is determined by placing a representative pole at a location where a control stability is secured.

19. The method of claim 12, comprising:
when a value of the third control signal is a positive number, applying the brake torques to the front-left and rear-left wheels; and
when the value of the third control signal is a negative number, applying braking torques to the front-right and rear-right wheels.

20. The method of claim 11, wherein the brake system includes at least one of an integrated dynamic brake (IDB) system, an anti-lock brake system (ABS) in the IDB, and an electronic stability control (ESC) logic.
